(19) United States
(12) Patent Application Publication
(10) Pub. No.: US 2026/0105660 A1
(43) Pub. Date: Apr. 16, 2026

(54) SEQUENTIAL STORYTELLING WITH GENERATIVE VIDEO

(71) Applicant: ADOBE INC., SAN JOSE, CA (US)

(72) Inventors: Zeke Koch, San Francisco, CA (US); Scott Matthew Frankel, Richmond, CA (US); John Warren Trezevant, Oakland, CA (US)

(21) Appl. No.: 19/250,432

(22) Filed: Jun. 26, 2025

Related U.S. Application Data
(60) Provisional application No. 63/707,392, filed on Oct. 15, 2024.

(51) Int. Cl. G06T 11/60; G06F 40/103; G06F 40/166

(52) U.S. Cl. CPC G06T 11/60; G06F 40/103; G06F 40/166

(57) ABSTRACT

A method, apparatus, non-transitory computer readable medium, and system for generating a synthetic video depicting a story includes obtaining a story prompt describing a story. Embodiments then generate a story recipe based on the story prompt using a text generation model. The story recipe includes a plurality of scene recipes. Embodiments then generate a plurality of scene videos based on the plurality of scene recipes, respectively, using a video generation model. Embodiments then generate the synthetic video depicting the story by combining the plurality of scene videos.

### CROSS-REFERENCE TO RELATED APPLICATION

This U.S. non-provisional application claims priority under 35 U.S.C. § 119 to U.S. Provisional Patent Application No. 63/707,392, filed on Oct. 15, 2024, in the United States Patent and Trademark Office, the disclosure of which is incorporated by reference herein in its entirety.

### BACKGROUND

The following relates generally to image processing, and more specifically to video generation. Image processing is a type of data processing that involves the manipulation of an image to get the desired output, typically utilizing specialized algorithms and techniques. It is a method used to perform operations on an image to enhance its quality or to extract useful information from it. This process usually comprises a series of steps that includes the importation of the image, its analysis, manipulation to enhance features or remove noise, and the eventual output of the enhanced image or salient information it contains.

Image processing techniques are also used for image generation. For example, machine learning (IL) techniques have been applied to create generative models that can produce new image content. One use for generative AI is to create images based on an input prompt. This task is often referred to as a “text to image” task or simply “text2img”. Some models such as GANs and Variational Autoencoders (VAEs) employ an encoder-decoder architecture with attention mechanisms to align various parts of text with image features. Newer approaches such as denoising diffusion probabilistic models (DDPMs) iteratively refine generated images in response to textual prompts. In some cases, image generation models can be used to create synthetic videos by generating images that make up frames of the video.

### SUMMARY

Embodiments of the present inventive concepts include systems and methods for generating synthetic videos, particularly videos that tell a story as described by an input prompt. Embodiments receive the input prompt from a user, and using a text generation model, process the input prompt to generate a “story recipe” which outlines structured attributes that will be used by additional generative models to create a synthetic video depicting the story. The story recipe may include, but is not limited to, multiple scene recipes, character recipes, and an edit decision list that determines the order and runtime length of the various scenes. Embodiments include an image generation model that is configured to generate images that are used as story keyframes, as well as images of characters in the story. At this point, the user may provide further edits to the initially generated content, including the scene keyframes, scene descriptions, characters, and pacing of the video. These edits may be made via a user interface and mapped to changes in the story recipe. Embodiments further include a video generation model that generates videos corresponding to each of the scenes based on description(s) from the corresponding scene recipe and visual information from the corresponding story keyframes. Embodiments then compose the generated scene videos together to form the final synthetic video.

A method, apparatus, non-transitory computer readable medium, and system for video generation are described. One or more aspects of the method, apparatus, non-transitory computer readable medium, and system include obtaining a story prompt describing a story; generating, using a text generation model, a story recipe based on the story prompt, wherein the story recipe includes a plurality of scene recipes, wherein each of the plurality of scene recipes includes a plurality of structured attributes; generating, using a video generation model, a plurality of scene videos based on the plurality of scene recipes, respectively; and generating a synthetic video depicting the story by combining the plurality of scene videos.

### BRIEF DESCRIPTION OF THE DRAWINGS

FIG. 1 shows an example of a video processing system according to aspects of the present disclosure.

FIG. 2 shows an example of a video processing apparatus according to aspects of the present disclosure.

FIG. 3 shows an example of a guided latent diffusion model according to aspects of the present disclosure.

FIG. 4 shows an example of a U-Net architecture according to aspects of the present disclosure.

FIG. 5 shows an example of a story generation pipeline according to aspects of the present disclosure.

FIG. 6 shows an example of a first user interface according to aspects of the present disclosure.

FIG. 7 shows an example of a second user interface that shows auto-generated scenes according to aspects of the present disclosure.

FIG. 8 shows an example of a third user interface that shows an empty storyboard according to aspects of the present disclosure.

FIG. 9 shows an example of a camera motion module according to aspects of the present disclosure.

FIG. 10 shows an example of a fourth user interface that shows a character edit screen according to aspects of the present disclosure.

FIG. 11 shows an example of a story recipe according to aspects of the present disclosure.

FIG. 12 shows an example of a character recipe according to aspects of the present disclosure.

FIG. 13 shows an example of a scene recipe according to aspects of the present disclosure.

FIG. 14 shows an example of an edit decision list according to aspects of the present disclosure.

FIG. 15 shows an example of a story treatment output according to aspects of the present disclosure.

FIG. 16 shows an example of a method for providing a story video to a user according to aspects of the present disclosure.

FIG. 17 shows an example of a diffusion process according to aspects of the present disclosure.

FIG. 18 shows an example of a machine learning model training algorithm according to aspects of the present disclosure.

FIG. 19 shows an example of a method a diffusion model training process according to aspects of the present disclosure.

FIG. 20 shows an example of a computing device according to aspects of the present disclosure.

FIG. 21 shows an example of a guided diffusion transformer (DiT) model according to aspects of the present disclosure.

### DETAILED DESCRIPTION

Image processing techniques, such as image generation, are frequently used in creative workflows. Historically, users would rely on manual techniques and drawing software to create visual content. The advent of machine learning (ML) has enabled new workflows that automate the image creation process.

ML is a field of data processing that focuses on building algorithms capable of learning from and making predictions or decisions based on data. It includes a variety of techniques, ranging from simple linear regression to complex neural networks, and plays a significant role in automating and optimizing tasks that would otherwise require extensive human intervention.

Storytelling is a complex creative task that involves conveying a narrative to an audience through a series of structured events or actions. Traditionally, storytelling has been done through a manual process, typically using a storyboard, in which scenes are sketched or described and then later refined into visual content. This method allows for careful planning of pacing, character development, and scene composition. However, the manual nature of this process means that it is often slow and labor-intensive.

Recently, users have adapted generative models to assist in their creative workflows. Generative models in ML are algorithms designed to generate new data samples that resemble a given dataset. Generative models are used in various fields, including image generation. They work by learning patterns, features, and distributions from a dataset and then using this understanding to produce new, original outputs.

Some conventional approaches for text-to-image generation include Generative Adversarial Networks (GANs), which have demonstrated impressive performance in generating realistic images from text prompts. However, GANs face challenges such as training instability and poor generalizability. Recent advancements in diffusion models have shown promise in generating high-quality images from text prompts. The text-to-image diffusion models incorporate a pre-trained text encoder that is configured to generate a text embedding from an input text, and features of the text embedding are combined with the intermediate image features during image synthesis using cross-attention.

Video generation, also known as text-to-video (T2V), is a recent application of generative models. Similar to text-to-image generation, T2V models aim to create a sequence of frames that form a video based on an input text prompt. These models leverage the same underlying principles of image generation, such as using text embeddings to influence the visual features of the generated content. However, present T2V video models are unable to generate lengthy sequences that can represent complex narratives. Currently, these models are best suited for producing short, simple videos-often just a few seconds long—with limited complexity. While they can generate visually coherent sequences, they struggle to maintain continuity across multiple scenes or depict detailed storylines. This limitation makes them unsuitable for applications that require more elaborate storytelling, which include character development, plot progression, and scene transitions.

Embodiments of the present inventive concepts improve the accuracy of video generation models by enabling users to create video depictions of a story with arbitrary duration and complexity. Embodiments include a video processing apparatus that receives a story prompt and creates a “story recipe” therefrom, where the story recipe includes details for the overall story, individual scenes, characters, and time codes. The scenes, also sometimes referred to as “story beats”, are laid out for a user in a storyboard user interface for any additional edits the user may wish to make. The user can make adjustments to the image representing the scene (the “story keyframe”), various descriptions of the scene, the characters included in the scene, the pacing and order of the scenes, and the like. Then, once all desired tweaks are made (image generation and text generation are relatively cheap operations during this phase), the video processing apparatus generates video clips for each of the scenes and composes them together to form a story video.

As used herein, a “recipe” refers to a body of text including structured attributes, e.g., key-value pairs arranged in a hierarchy, that describes some aspect of the story. For example, the story recipe may include an attribute that references the scenes to be included in the story, as well as an attribute that references the characters to be included in the story. Similarly, a scene recipe may include attributes that describe the scene, such as scene name, characters, camera attributes, style attributes, and the like. In some cases, the attributes include generative prompts that are input to generative models such as image generation models, sound generation models, and video generation models to generate assets for the scene.

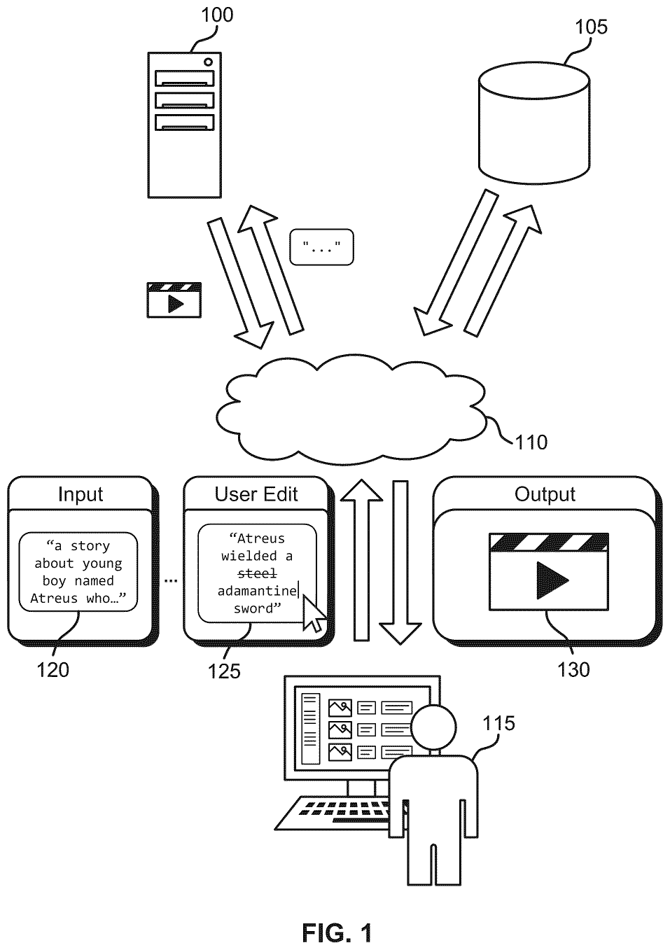

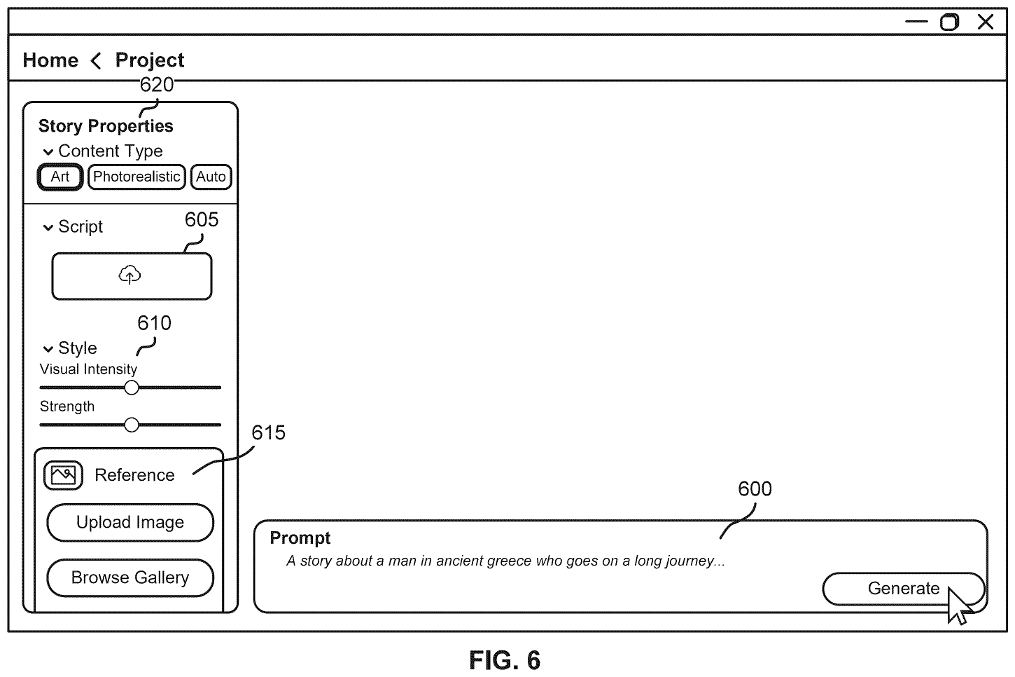

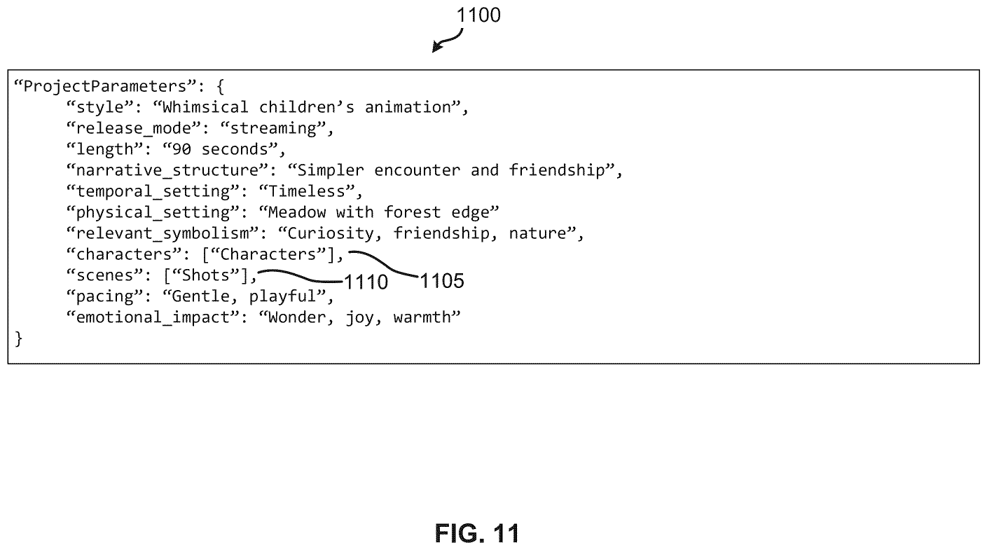

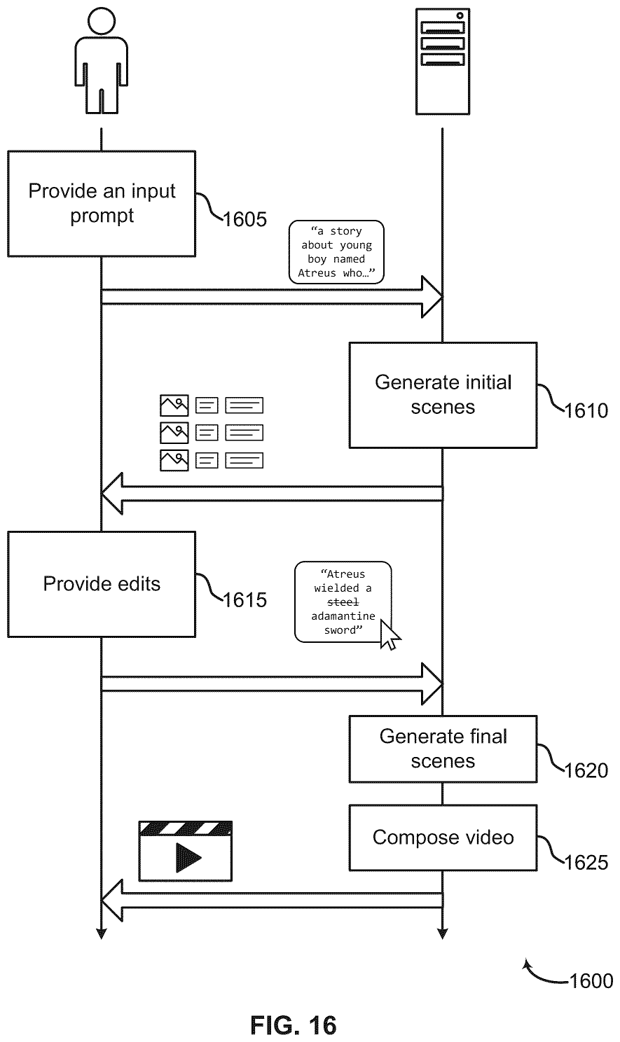

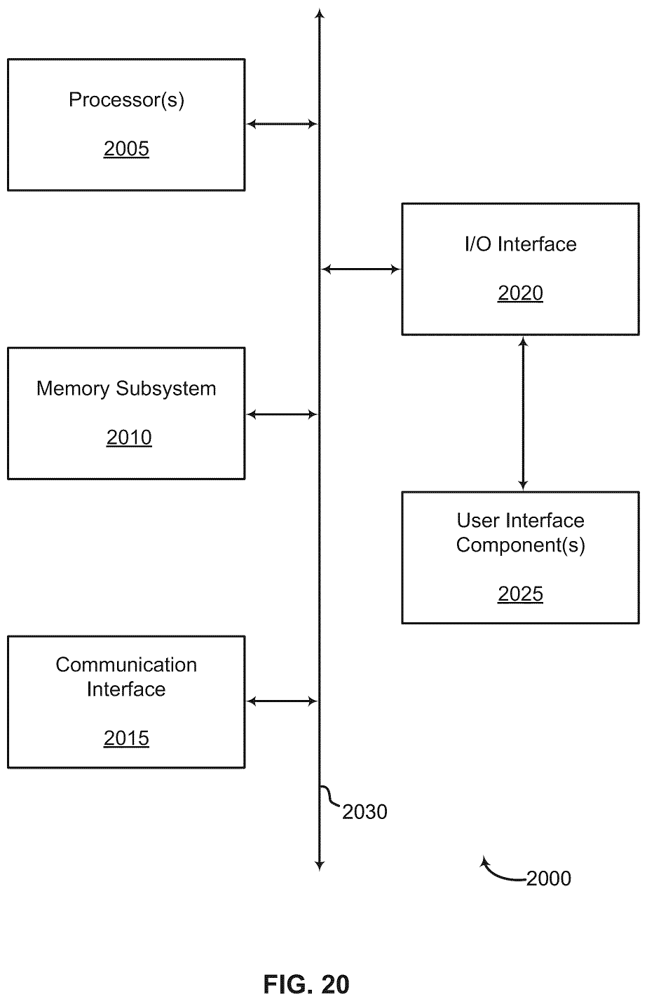

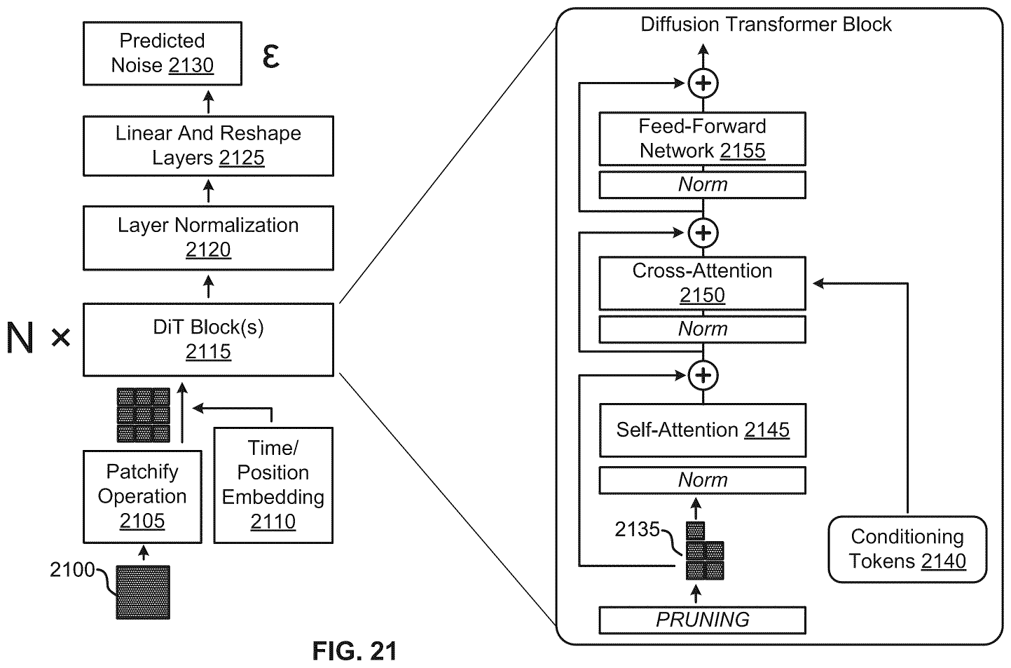

Embodiments of a video processing system are described with reference to FIGS. 1-5. User interface elements are described with reference to FIGS. 6-10. Example text outputs, including story recipes, scene recipes, character recipes, and the like, are described with reference to FIGS. 11-15. Methods for generating synthetic videos and for training machine learning models are provided with reference to FIGS. 16-19. A computing device configured to implement a video processing apparatus is described with reference to FIG. 20. A variant of an image and video generation model is described with reference to FIG. 21.

### Video Processing System

FIG. 1 shows an example of a video processing system according to aspects of the present disclosure. The example shown includes video processing apparatus 100, database 105, network 110, user 115, text input 120, edit command 125, and synthetic video 130.

In an example process, user 115 provides text input 120, which may be a story prompt that describes a story. The video processing apparatus 100 processes text input 120 to generate a storyboard including a plurality of scenes and characters. The backend data structure that defines the storyboard is herein referred to as a “story recipe”, may be in the form of, for example, a JSON object. The user 115 then edits the generated content, e.g., with edit command 125, which video processing apparatus 100 propagates to the storyboard. When the user presses a “generate video” button, the video processing apparatus 100 generates videos for each of the scenes and composes them together in to form synthetic video 130 which is then provided back to user 115.

In some embodiments, one or more components of video processing apparatus 100 are implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a super computer, or any other suitable processing apparatus.

Database 105 is configured to store information used by the video processing system. For example, database 105 may store training data, model parameters, generated texts, generated images, generated videos, and the like. A database is an organized collection of data. For example, a database stores data in a specified format known as a schema. A database may be structured as a single database, a distributed database, multiple distributed databases, or an emergency backup database. In some cases, a database controller may manage data storage and processing in a database. In some cases, a user interacts with the database controller. In other cases, the database controller may operate automatically without user interaction.

Network 110 facilitates the transfer of information between video processing apparatus 100, database 105, and user 115. In some cases, network 110 is referred to as a “cloud”. A cloud is a computer network configured to provide on-demand availability of computer system resources, such as data storage and computing power. In some examples, the cloud provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

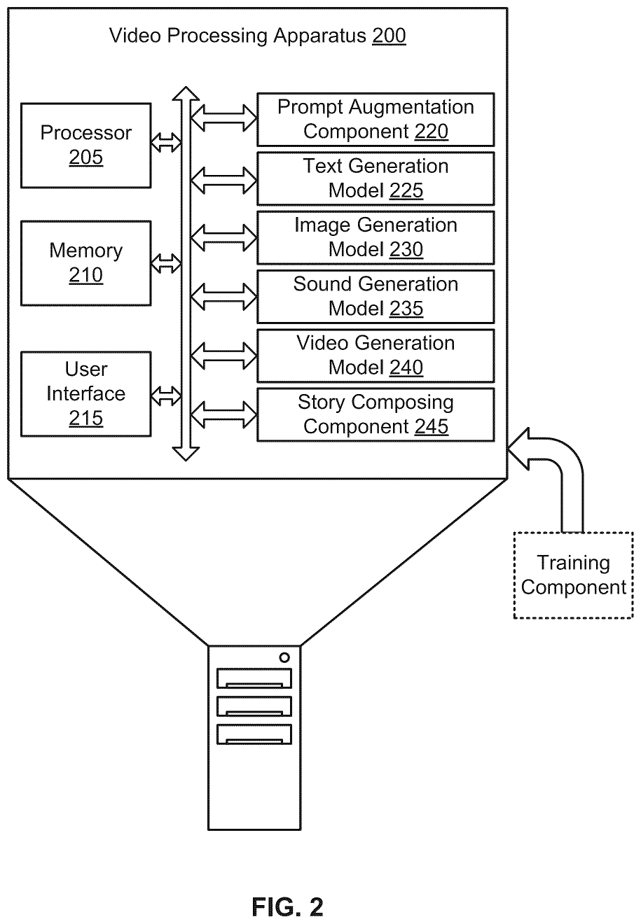

FIG. 2 shows an example of a video processing apparatus 200 according to aspects of the present disclosure. The example shown includes video processing apparatus 200, processor 205, memory 210, user interface 215, prompt augmentation component 220, text generation model 225, image generation model 230, sound generation model 235, video generation model 240, and story composing component 245.

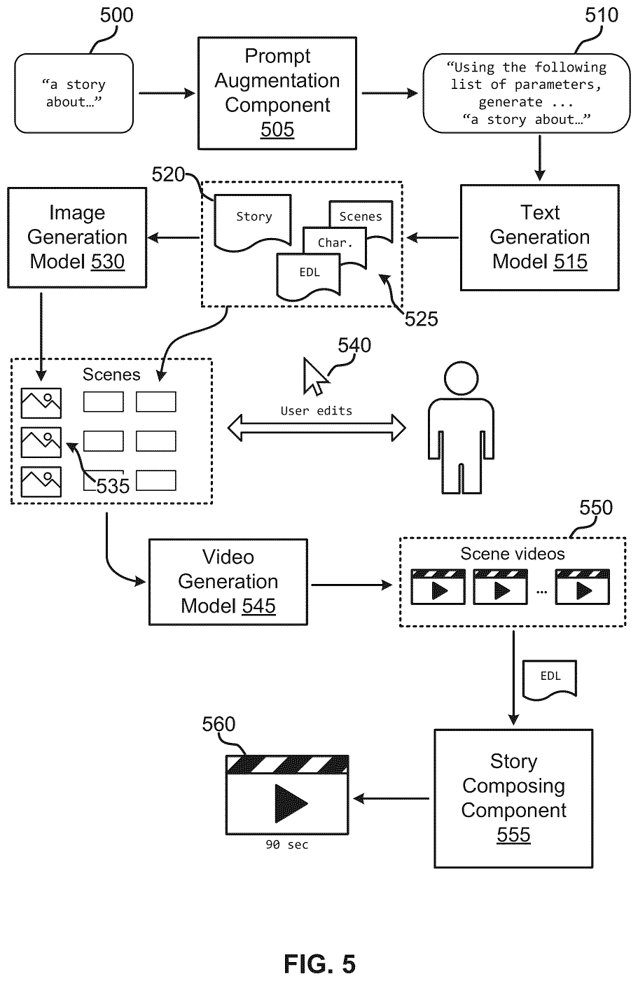

Video processing apparatus 200 is an example of, or includes aspects of, the corresponding element described with reference to FIG. 1. Prompt augmentation component 220 is an example of, or includes aspects of, the corresponding element described with reference to FIG. 5. Text generation model 225 is an example of, or includes aspects of, the corresponding element described with reference to FIG. 5. Image generation model 230 is an example of, or includes aspects of, the corresponding element described with reference to FIG. 5. Video generation model 240 is an example of, or includes aspects of, the corresponding element described with reference to FIG. 5. Story composing component 245 is an example of, or includes aspects of, the corresponding element described with reference to FIG. 5.

The video processing apparatus 200 described herein may include several components. These components are variously named and are described so as to partition the functionality enabled by the processor(s) and the executable instructions included in the computing devices used to implement the apparatuses (such as the computing device described with reference to FIG. 20). In some examples, the partitions are implemented physically, such as through the use of separate circuits or processors for each component. In some examples, the partitions are implemented logically via the architecture of the code executable by the processors.

Processor 205 is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the processor is configured to operate a memory array using a memory controller. In other cases, a memory controller is integrated into the processor. In some cases, the processor is configured to execute computer-readable instructions stored in a memory to perform various functions. In some embodiments, a processor includes special purpose components for modem processing, baseband processing, digital signal processing, or transmission processing.

Memory 210 stores information used by video processing apparatus 200, such as data, instructions executable by processor 205, machine learning model parameters, configurations, and the like. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

User interface 215 enables a user to interact with image processing apparatus 200. In some embodiments, user interface 215 includes an audio device, such as an external speaker system, an external display device such as a display screen, or an input device (e.g., remote control device interfaced with the user interface directly or through an IO controller module). In some cases, a user interface may be a graphical user interface (GUI).

Components of video generation apparatus 200 may include an artificial neural network (ANN) architecture. For example, text generation model 225, image generation model 230, sound generation model 235, and video generation model 240 may be based on an ANN architecture.

An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes may determine their output using other mathematical algorithms (e.g., selecting the max from the inputs as the output) or any other suitable algorithm for activating the node. Each node and edge is associated with one or more node weights that determine how the signal is processed and transmitted.

During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

Prompt augmentation component 220 is configured to take an input text and augment it with additional text. According to some aspects, prompt augmentation component 220 augments an input story prompt with additional text including instructions to text generation model 225. The instructions may specify a schema for the structured attributes included in the story recipes, scene recipes, character recipes, and the like, and may prompt the model to infill one or more of the values of the structured attributes based on the content of the story prompt.

Text generation model 225 is configured to generate additional text based on an input text. For example, text generation model 225 may receive the augmented prompt from prompt augmentation component 220 and generate a story recipe therefrom. As described herein, the story recipe may include additional recipes such as scene recipes, character recipes, edit decision lists, and the like. In some embodiments, the additional recipes are separate from the story recipe, and/or referenced by the story recipe. Embodiments of text generation model 225 include a transformer-based generative model such as GPT-2, GPT-3, and the like.

A transformer or transformer network is a type of neural network models used for natural language processing tasks. A transformer network transforms one sequence into another sequence using an encoder and a decoder. Encoder and decoder include modules that can be stacked on top of each other multiple times. The modules comprise multi-head attention and feed forward layers. The inputs and outputs (target sentences) are first embedded into an n-dimensional space. Positional encoding of the different words (i.e., give every word/part in a sequence a relative position since the sequence depends on the order of its elements) are added to the embedded representation (n-dimensional vector) of each word. In some examples, a transformer network includes attention mechanism, where the attention looks at an input sequence and decides at each step which other parts of the sequence are important. The attention mechanism involves query, keys, and values denoted by Q, K, and V, respectively. Q is a matrix that contains the query (vector representation of one word in the sequence), K are all the keys (vector representations of all the words in the sequence) and V are the values, which are again the vector representations of all the words in the sequence. For the encoder and decoder, multi-head attention modules, V consists of the same word sequence than Q. However, for the attention module that is taking into account the encoder and the decoder sequences, V is different from the sequence represented by Q. In some cases, values in V are multiplied and summed with some attention-weights a.

A transformer or transformer network is a type of neural network models used for natural language processing tasks. A transformer network transforms one sequence into another sequence using an encoder and a decoder. Encoder and decoder include modules that can be stacked on top of each other multiple times. The modules comprise multi-head attention and feed forward layers. The inputs and outputs (target sentences) are first embedded into an n-dimensional space. Positional encoding of the different words (i.e., give every word/part in a sequence a relative position since the sequence depends on the order of its elements) are added to the embedded representation (n-dimensional vector) of each word. In some examples, a transformer network includes attention mechanism, where the attention looks at an input sequence and decides at each step which other parts of the sequence are important. The attention mechanism involves query, keys, and values denoted by Q, K, and V, respectively. Q is a matrix that contains the query (vector representation of one word in the sequence), K are all the keys (vector representations of all the words in the sequence) and V are the values, which are again the vector representations of all the words in the sequence. For the encoder and decoder, multi-head attention modules, V consists of the same word sequence than Q. However, for the attention module that is taking into account the encoder and the decoder sequences, V is different from the sequence represented by Q. In some cases, values in V are multiplied and summed with some attention-weights a.

Diffusion Transformers (DiTs) adapt the transformer architecture for image generation tasks by treating image patches as sequence elements analogous to words in text. In DiTs, an input image is first divided into patches which are linearly embedded into tokens. These tokens are augmented with learned positional embeddings to maintain spatial relationships. The tokens are then processed through a series of transformer blocks that may include self-attention mechanisms for modeling relationships between patches, cross-attention layers for incorporating conditional information such as text prompts, and feed-forward networks. Unlike language transformers which predict the next token in a sequence, DiTs are trained to predict noise that has been added to the input image according to a predefined diffusion schedule, enabling the model to gradually denoise corrupted images during the generation process.

DiTs may also be used to generate audio samples. An audio encoder may tokenize and encode noise samples, analogous to the noise image patches above. For example, the audio encoder may process an input waveform of audio, which typically has a high sample rate (e.g., 44,100 Hz), and generate tokenized embeddings in a latent space at a wider sampling rate, such as 40 Hz. This transformation reduces the complexity of the audio data while retaining essential features, enabling efficient processing and generation tasks. The DiT may then generate audio samples by iteratively reducing the noise of the inputs as described above. Both audio generation and image/video generation may be conditioned with external signals such as text prompts, reference images, and the like. Additional detail regarding an example DiT is described with reference to FIG. 21.

According to some aspects, text generation model 225 generates a story recipe based on the story prompt, where the story recipe includes a set of scene recipes, where each of the set of scene recipes includes a set of structured attributes. In some examples, text generation model 225 autoregressively generates a sequence of tokens corresponding to the story recipe. In some aspects, the story recipe includes a character recipe including a set of structured attributes for a character in the story. In some aspects, the story recipe describes a dialogue, where the synthetic video includes audio corresponding to the dialogue. In some aspects, the story recipe includes camera view information, where the synthetic video is based on the camera view information. In some examples, text generation model 225 updates the story recipe based on the edit command to obtain an updated story recipe, where the synthetic video is based on the updated story recipe.

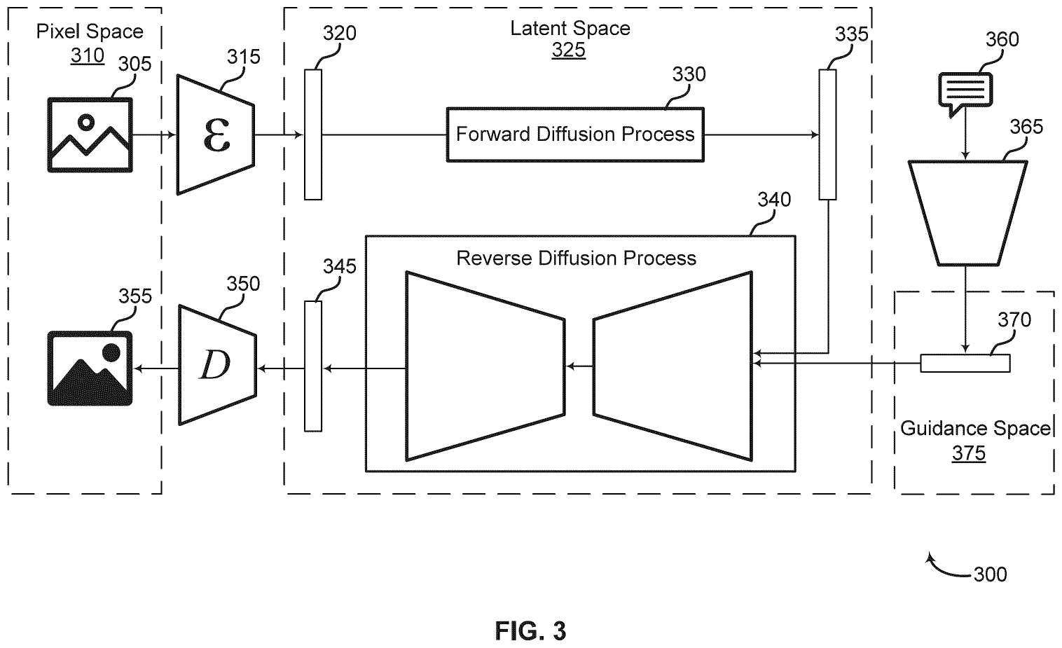

Image generation model 230 is configured to generate images. Image generation model 230 may, for example, generate images based on an input condition, such as a text description or a reference image. Image generation model 230 may be used to generate scene keyframes, which are in turn used to condition the generation of scene videos by video generation model 240. According to some aspects, image generation model 230 generates a character image based on a character recipe, where each of the set of scenes is based on the character image. Embodiments of image generation model 230 include but are not limited to a diffusion-based model. Additional detail regarding an example of a diffusion model will be described with reference to FIG. 3.

Sound generation model 235 is configured to generate sound from text. The scene recipe and other recipes produced by text generation model 225 may specify sound generation prompts. The sound generation model 235 may generate sound assets based on each of the sound generation prompts, and story composing component 245 may compose these sounds with a plurality of scene videos generated from video generation model 240 according to, e.g., the recipes or an edit decision list. Embodiments of sound generation model 235 include diffusion-based models which generate a spectrogram image based on features from a text prompt. Other embodiments include models that generate raw waveform audio by predicting a sequence of latent variables that are then decoded into sound. These sound generation models may use additional techniques such as vocoders to convert the intermediate representations into high-quality audio signals.

Video generation model 240 is configured to generate videos. Video generation model 240 may generate videos based on an input condition, such as a text description, a reference image, or a reference video. According to some aspects, video generation model 240 generates a set of scene videos based on the set of scene recipes, respectively. Embodiments of video generation model 240 include a diffusion-based model. For example, video generation model 240 may include an image generation model that has been adapted with temporal layers, and that has been fine-tuned to generate a sequence of frames rather than a single image.

Story composing component 245 is configured to combine a plurality of scene videos together to form a final synthetic video. Embodiments of story composing component 245 obtain an edit decision list including start and stop time codes for each scene of a set of scenes and compose the plurality of scene videos based on the edit decision list. Story composing component may combine other data, such as generated sounds, with the plurality of scene videos. According to some aspects, story composing component 245 generates a synthetic video depicting the story by combining the set of scene videos.

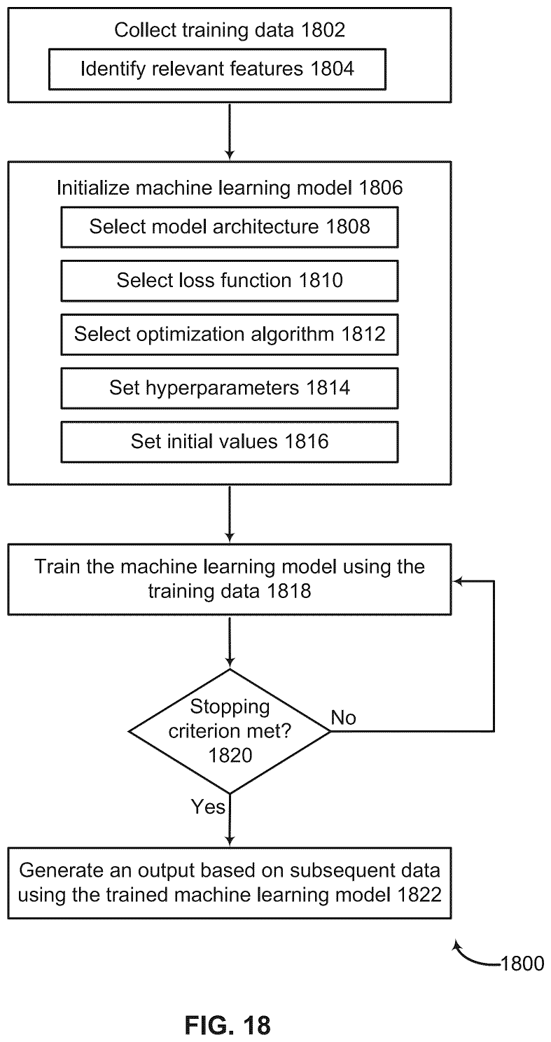

Some embodiments further include a training component configured to initialize and/or update parameters of text generation model 225, image generation model 230, sound generation model 235, video generation model 240, or some combination thereof. The operations of the training component are described in further detail with reference to FIG. 18.

FIG. 3 shows an example of a guided latent diffusion model 300 according to aspects of the present disclosure. The guided latent diffusion model 300 depicted in FIG. 3 is an example of, or includes aspects of, the image generation model 230, the sound generation model 235, and/or the video generation model 240 described with reference to FIG. 2.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 300 may take an original image 305 in a pixel space 310 as input and apply and image encoder 315 to convert original image 305 into original image features 320 in a latent space 325. Then, a forward diffusion process 330 gradually adds noise to the original image features 320 to obtain noisy features 335 (also in latent space 325) at various noise levels.

Next, a reverse diffusion process 340 (e.g., a U-Net ANN) gradually removes the noise from the noisy features 335 at the various noise levels to obtain denoised image features 345 in latent space 325. In some examples, the denoised image features 345 are compared to the original image features 320 at each of the various noise levels, and parameters of the reverse diffusion process 340 of the diffusion model are updated based on the comparison. Finally, an image decoder 350 decodes the denoised image features 345 to obtain an output image 355 in pixel space 310. In some cases, an output image 355 is created at each of the various noise levels. The output image 355 can be compared to the original image 305 to train the reverse diffusion process 340.

In some cases, image encoder 315 and image decoder 350 are pre-trained prior to training the reverse diffusion process 340. In some examples, they are trained jointly, or the image encoder 315 and image decoder 350 and fine-tuned jointly with the reverse diffusion process 340.

The reverse diffusion process 340 can also be guided based on a text prompt 360, or another guidance prompt, such as an image, a layout, a segmentation map, etc. The text prompt 360 can be encoded using a text encoder 365 (e.g., a multimodal encoder) to obtain guidance features 370 in guidance space 375. The guidance features 370 can be combined with the noisy features 335 at one or more layers of the reverse diffusion process 340 to ensure that the output image 355 includes content described by the text prompt 360. For example, guidance features 370 can be combined with the noisy features 335 using a cross-attention block within the reverse diffusion process 340. The process may be repeated to generate frames of a video or may be carried out on a spectrogram data and passed through a vocoder to generate sound. According to some aspects, diffusion models that are used to generate videos and/or sound may include additional architectural adaptations, such as temporal layers that ensure coherency between frames or waveforms.

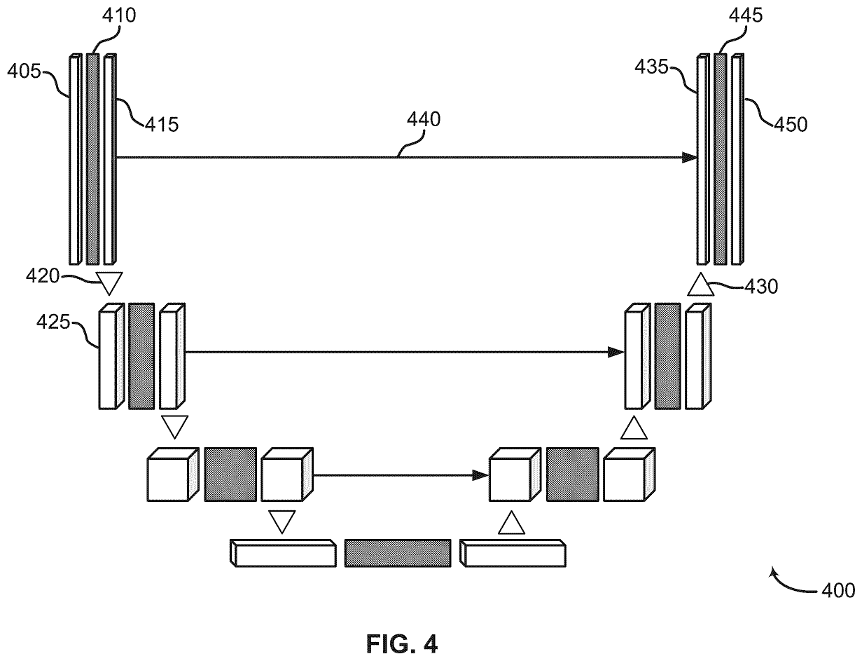

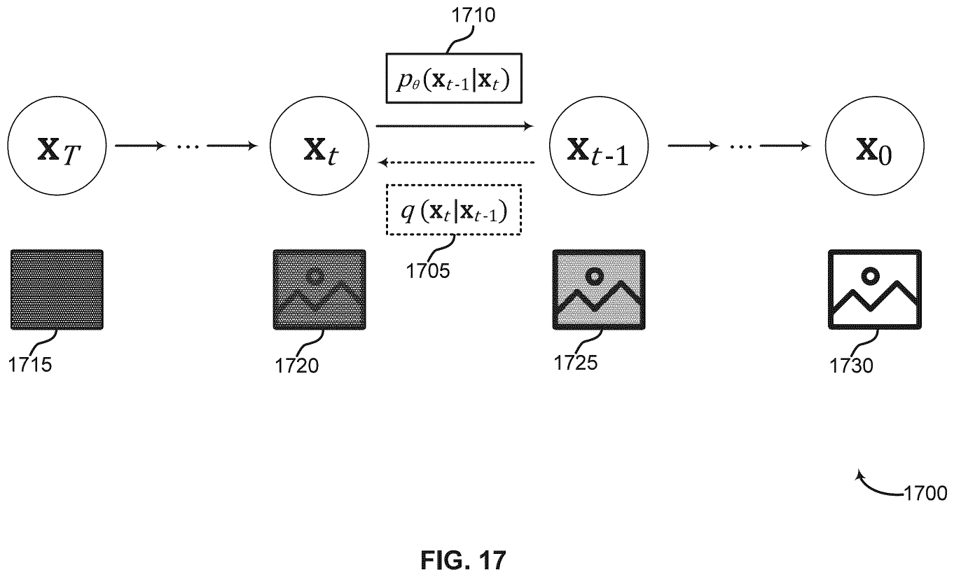

FIG. 4 shows an example of a U-Net 400 according to aspects of the present disclosure. In some examples, U-Net 400 is an example of the component that performs the reverse diffusion process 340 of guided diffusion model 300 described with reference to FIG. 3 and includes architectural elements of the image generation model 230 described with reference to FIG. 2. The U-Net 400 depicted in FIG. 4 is an example of, or includes aspects of, the architecture used within the reverse diffusion process described with reference to FIG. 17.

In some examples, diffusion models are based on a neural network architecture known as a U-Net. The U-Net 400 takes input features 405 having an initial resolution and an initial number of channels and processes the input features 405 using an initial neural network layer 410 (e.g., a convolutional network layer) to produce intermediate features 415. The intermediate features 415 are then down-sampled using a down-sampling layer 420 such that down-sampled features 425 have a resolution less than the initial resolution and a number of channels greater than the initial number of channels.

This process is repeated multiple times, and then the process is reversed. That is, the down-sampled features 425 are up-sampled using up-sampling process 430 to obtain up-sampled features 435. The up-sampled features 435 can be combined with intermediate features 415 having a same resolution and number of channels via a skip connection 440. These inputs are processed using a final neural network layer 445 to produce output features 450. In some cases, the output features 450 have the same resolution as the initial resolution and the same number of channels as the initial number of channels.

In some cases, U-Net 400 takes additional input features to produce conditionally generated output. For example, the additional input features could include a vector representation of an input prompt. The additional input features can be combined with the intermediate features 415 within the neural network at one or more layers. For example, a cross-attention module can be used to combine the additional input features and the intermediate features 415. Embodiments of the image generation model described herein may combine anchor features in a similar manner, but instead of adding the influence of the anchor features, embodiments may subtract the influence. This can be achieved by computing attention weights for the anchor features and then subtracting the resulting weighted features from the intermediate features 415. By doing so, the model reduces the presence of elements associated with the anchor features in the generated output.

FIG. 5 shows an example of a story generation pipeline according to aspects of the present disclosure. The example shown includes text input 500, prompt augmentation component 505, augmented text input 510, text generation model 515, story recipe 520, additional recipes 525, image generation model 530, image keyframes 535, user edits 540, video generation model 545, scene videos 550, story composing component 555, and. Many of the elements shown in FIG. 5 are examples of, or include aspects of, the corresponding elements described with reference to FIG. 2.

In this example, a user provides text input 500 into the system. Then, prompt augmentation component 505 adds text to text input 500 to obtain augmented text input 510. The additional text includes instructions to a language model (e.g. text generation model 515) to utilize the content of text input 500 to generate the content of story recipe 520 and additional recipes 525. For example, the additional instructions may specify a list of structured attributes, e.g., key-value pairs, and what types of values each attribute should have so as to be in accordance with the story described by text input 510. The story recipe 520 and additional recipes 525 include descriptions of the overall story, scenes, characters, and in some cases, sounds such as music, sound FX, and dialogue. The story recipe 520 and additional recipes 525 may also include prompts for generating images, sounds, and videos.

Image generation model 530 utilizes image generation prompts from story recipe 520 and additional recipes 525 to generate scene key frames for each scene. The scene key frames are used, sometimes along with additional text description, to later generate scene videos for each scene. Image generation model 530 may also generate image(s) for each character in the story. The scene description(s), character description(s), and scene key frames are arranged in a Scenes storyboard, which a user can then edit to their desired state.

The system obtains user edits 540 and updates the recipes and the storyboard therefrom. Once the user has finished their editing, the user may then press a “generate story” button or similar, at which point the content generated thus far is passed to video generation model 545. Video generation model 545 generates a plurality of scene videos (e.g., scene videos 550) corresponding to the plurality of scenes, respectively, based on the descriptions and the key frame images from the storyboard. The story composing component 555 then pieces together the scene videos and any other assets including images or sounds according to an Edit Decision List document that was also initially generated by text generation model 515, thereby forming synthetic video 560.

FIG. 6 shows an example of a first user interface according to aspects of the present disclosure. The example shown includes prompt input element 600, script input element 605, style adjustment element 610, reference content element 615, and additional parameters element 620.

In this example, a user is prompted to begin the process of generating a story video by entering a story prompt into prompt input element 600. Additional controls may be available at this stage, such as: the option to upload a story script via script input element 605; the option to upload a style reference via reference content element 615; the option to choose the strength of the style reference as applied to the generated story video via style adjustment element 610; and the option to specify a style category via additional parameters element 620.

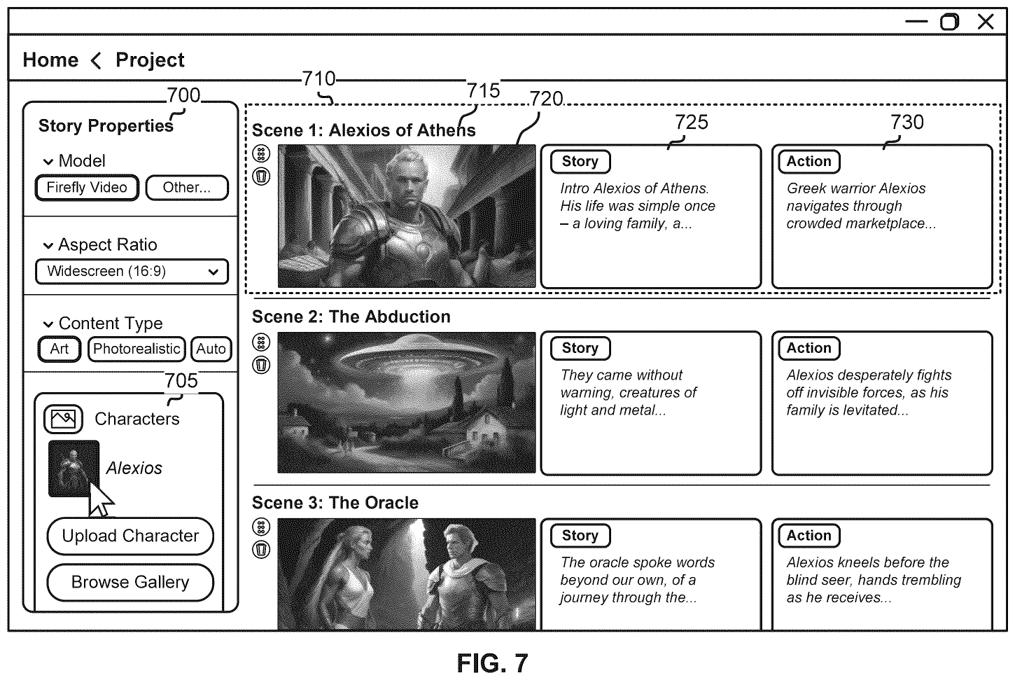

FIG. 7 shows an example of a second user interface that shows auto-generated scenes according to aspects of the present disclosure. The example shown includes settings element 700, characters module 705, and first scene 710. In one aspect, first scene 710 includes scene title 715, scene keyframe 720, scene story description 725, and scene action description 730.

Upon entering a story prompt, the user may be greeted by the second user interface, which depicts a storyboard that includes scenes generated by the video processing system. For example, as described in FIG. 2 and FIG. 5, the text generation component may generate a story recipe, scene recipes, character recipes, and an edit decision list from an augmented version of the input story prompt.

In this example, the user may: change one or more of the available generative models for images, video, and sound via includes settings element 700; create a new character or select from existing characters via characters module 705; and make alterations to a scene, e.g., first scene 710.

In one aspect, first scene 710 includes scene title 715, scene keyframe 720, story description 725, and action description 730. The user may edit any one of these attributes of the scene by selecting the corresponding element and providing input. For example, the user may edit scene keyframe 720 by uploading a new image or providing an image generation prompt. The user may adjust the details of the scene by adjusting scene story description 725, scene action description 730, or both, which will affect the generated story video for first scene 710.

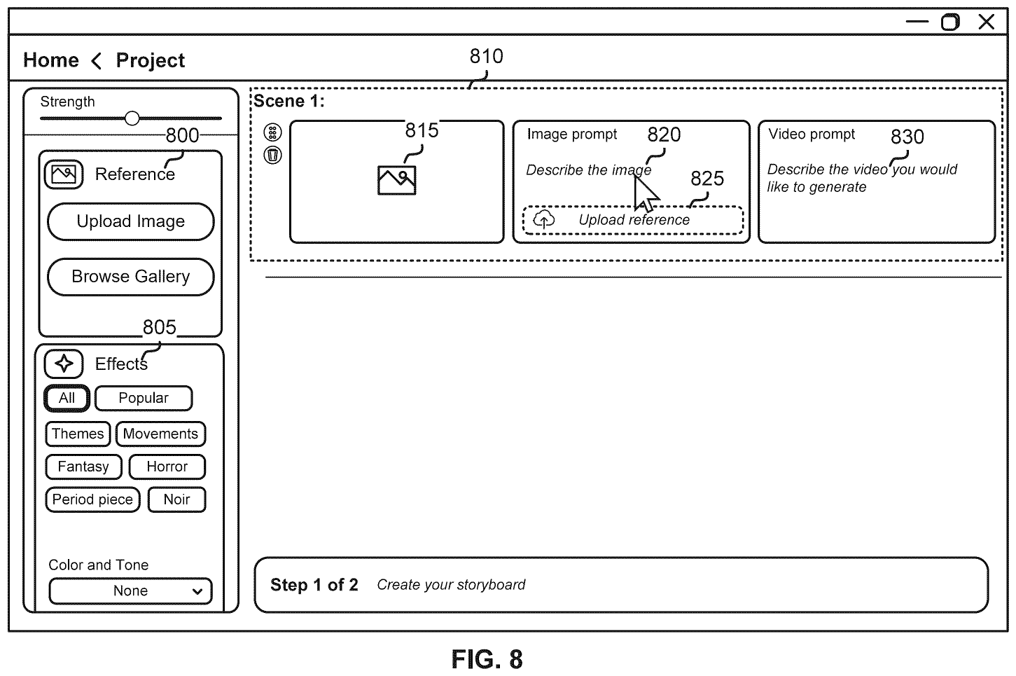

FIG. 8 shows an example of a third user interface that shows an empty storyboard according to aspects of the present disclosure. The example shown includes reference content element 800, effects element 805, and first blank scene 810.

In some cases, rather than provide an initial prompt, a user may opt to create their own storyboard with the power of generative AI manually. Accordingly, the user will be greeted with the third user interface as depicted in FIG. 8. The user may: upload a reference image or other content via reference element 800 and change the look of one or more scenes via effects element 805.

In one aspect, first blank scene 810 includes scene keyframe upload element 815, scene keyframe text input element 820, scene keyframe reference image upload element 825, and scene video prompt input element 830. The user may edit various aspects of the scene e.g., as described with reference to FIG. 7. The user may: directly upload a scene keyframe via scene keyframe upload element 815; describe a scene keyframe by providing an image generation prompt via scene keyframe text input element 820; upload a reference image that affects the style and/or connect of the scene keyframe via scene keyframe reference image upload element 825; and describe the scene video the user wishes to generate via scene video prompt input element 830 (also referred to herein as the scene action description).

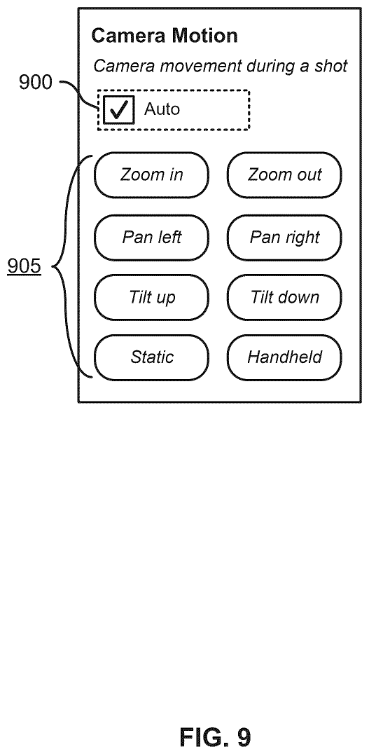

FIG. 9 shows an example of a camera motion module according to aspects of the present disclosure. The example shown includes an auto camera motion selector 900 and specific camera motion selectors 905.

The camera motion module may be used to specify the shot style of one or more scenes in the storyboard. The auto camera motion selector 900 indicates that the video processing system will choose the shot style automatically. For example, the video processing system may choose a shot style based on the generated or provided scene action description or may select the shot style based on a stochastic process. The specific camera motion selectors 905 may be selected by a user to specify a specific shot style for one or more scenes in the storyboard.

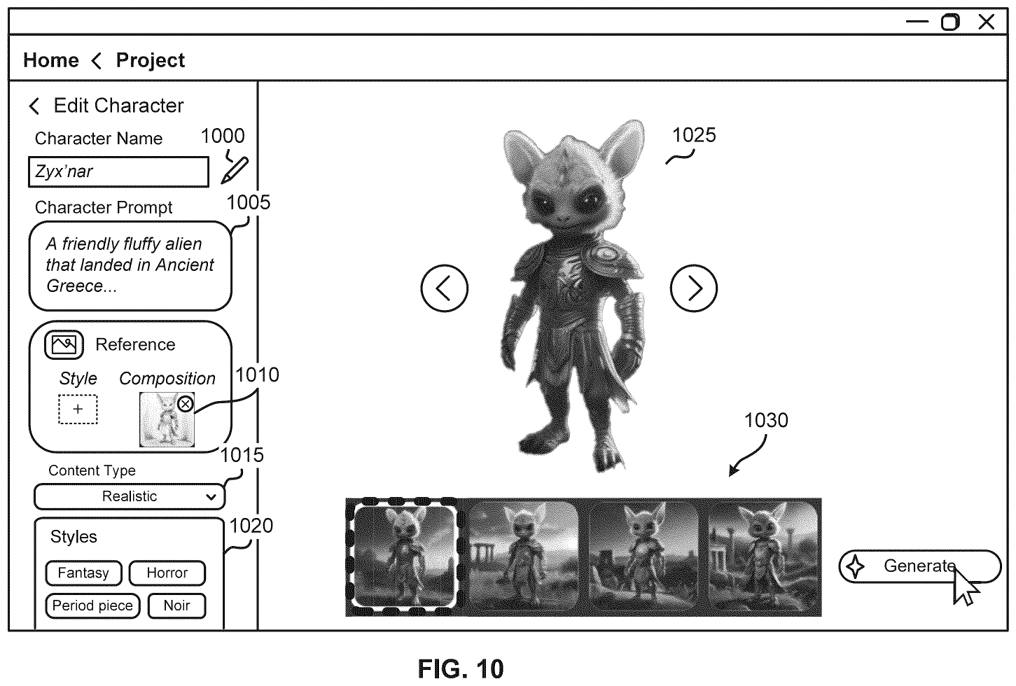

FIG. 10 shows an example of a fourth user interface that shows a character edit screen according to aspects of the present disclosure. The example shown includes character name element 1000, character prompt element 1005, character reference image element 1010, character content type element 1015, character style element 1020, selected character version 1025, and character variants 1030.

A user may interact with the fourth user interface upon selecting one or more elements from characters module 705 as described with reference to FIG. 7. The fourth user interface allows a user to select or generate characters for use in the story. The user may: specify a character's name via character name element 1000; provide a character generation prompt via character prompt element 1005; upload a reference image to condition the generation of the character via character reference image element 1010; specify a character content type (e.g., cartoon, realistic, etc.) via character content type element 1015; and specify a style of the character via character style element 1020.

The fourth user interface displays the selected character version 1025 in the center of the screen. The character can be rotated using one of the arrow elements placed next to selected character version 1025. According to some aspects, an image generation model is configured to generate multiple views of a character based on a reference image, a text prompt, a rotation instruction, or some combination thereof. Additional variants, e.g., character variants 1030, are selectable and displayed beneath the selected character.

### Story Recipes

FIG. 11 shows an example of a story recipe according to aspects of the present disclosure. The example shown includes story structured attributes 1100, character recipes reference 1105, and scene recipes reference 1110.

In this example, the story recipe includes structured attributes 1100 including key and value pairs. The story recipe includes keys for style, release mode, length, narrative structure, temporal setting, physical setting, relevant symbolism, characters, pacing, and emotional impact. The corresponding values of the keys may be generated from a text generation model as described with reference to FIG. 2. In some embodiments, a user may adjust the generated values via a user interface as described with reference to FIGS. 6-7. The structured attributes may be used while prompting an image generation model, a sound generation model, a video generation model, or a combination thereof when generating images, sounds, and videos for the story video.

For example, character recipes reference 1105 may be a key-value pair that references another set of structured attributes, e.g., a character recipes object or multiple character recipe objects, for inclusion in the story. The scene recipes reference 1110 may be a key-value pair that references a scene recipes object or multiple scene recipe objects that represent the scenes to include in the story.

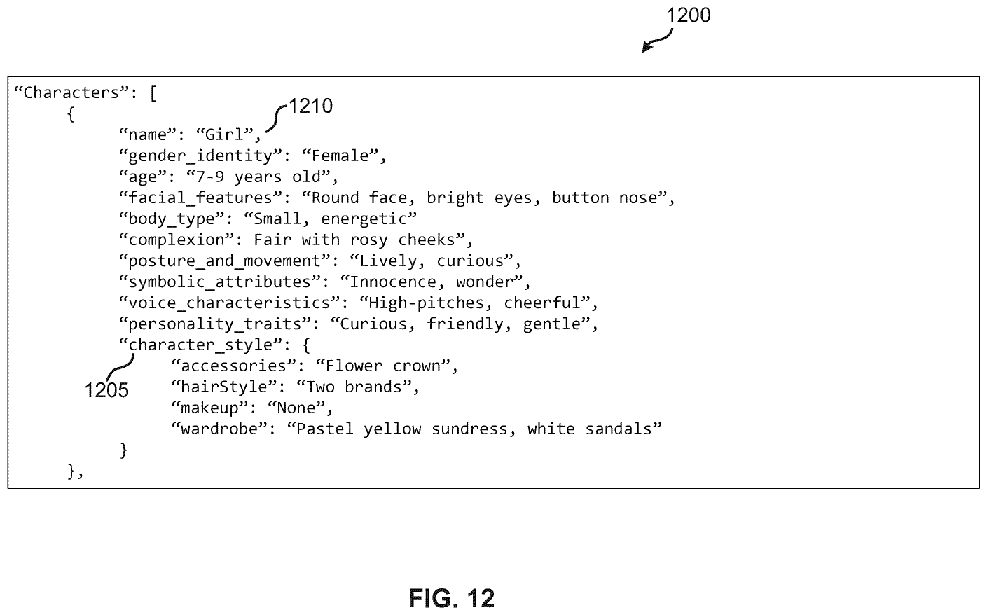

FIG. 12 shows an example of a character recipe according to aspects of the present disclosure. The example shown includes character structured attributes 1200, character style attribute 1205, and character name attribute 1210.

The character recipe specifies a plurality of characters, though characters after “Girl” are not shown in the example. The character style attribute 1205 and the character name attribute 1210 each may contain keys and values that are used when prompting an image generation model to create images of the character. Accordingly, a video generation model which uses the images and the names of the characters of the conditioning to the generative process will generate synthetic videos in which the character appears. Similar to the story recipe, a text generation model may adhere to a structure as described from an augmented text prompt and generate values for the keys of the character recipe. The keys and values may be used while prompting an image generation model, a sound generation model, a video generation model, or a combination thereof when generating images, sounds, and videos for the story video.

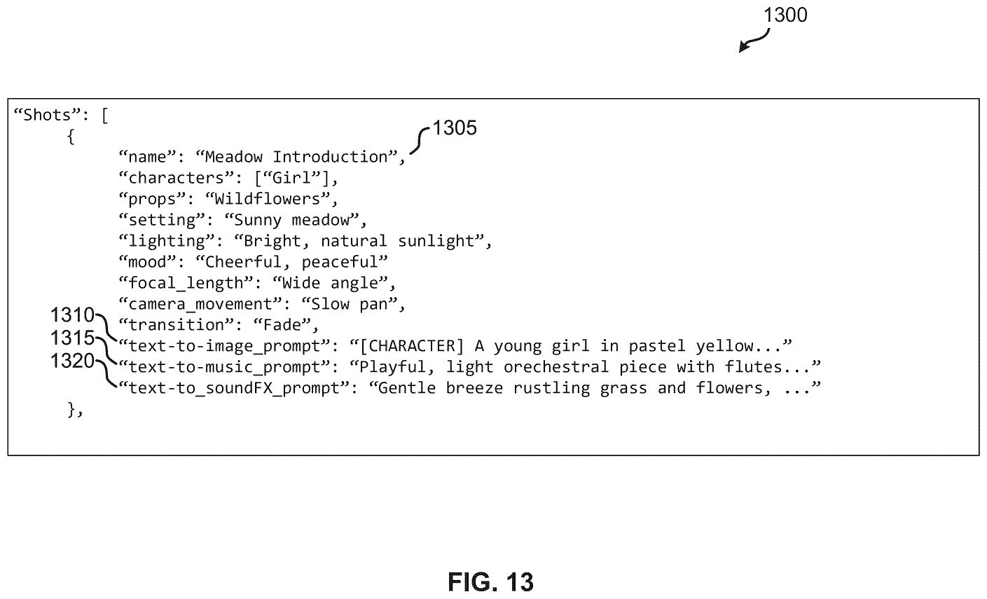

FIG. 13 shows an example of a scene recipe according to aspects of the present disclosure. The example shown includes scene structured attributes 1300, scene name attribute 1305, scene image prompt 1310, scene music prompt 1315, and scene sound fx prompt 1320.

The scene recipe describes the details for a plurality of scenes, also referred to as “shots” herein. The scene recipe includes structured attributes for several aspects of the scene, including the scene name, characters to include in the scene, objects and settings, lightings, mood, pace, atmosphere, and others. The structured attributes may also include generative prompts such as scene image prompt 1310, scene music prompt 1315, and scene sound fx prompt 1320. An image generation model and a sound generation model may use these prompts to generate assets for the scene. For example, the sound generation model may use scene music prompt 1315 to generate music for the scene, and scene sound fx prompt 1320 to generate different sound effects for the scene. In some embodiments, the system includes different models for music generation and sound effect generation.

A video generation model may generate the scene video based on these prompts and the generated assets, as well as an action description of the scene. In at least one embodiment, the video generation model utilizes an image generated based on scene image prompt 1310 as well as one or more text describing the scene as conditioning for generating the scene video.

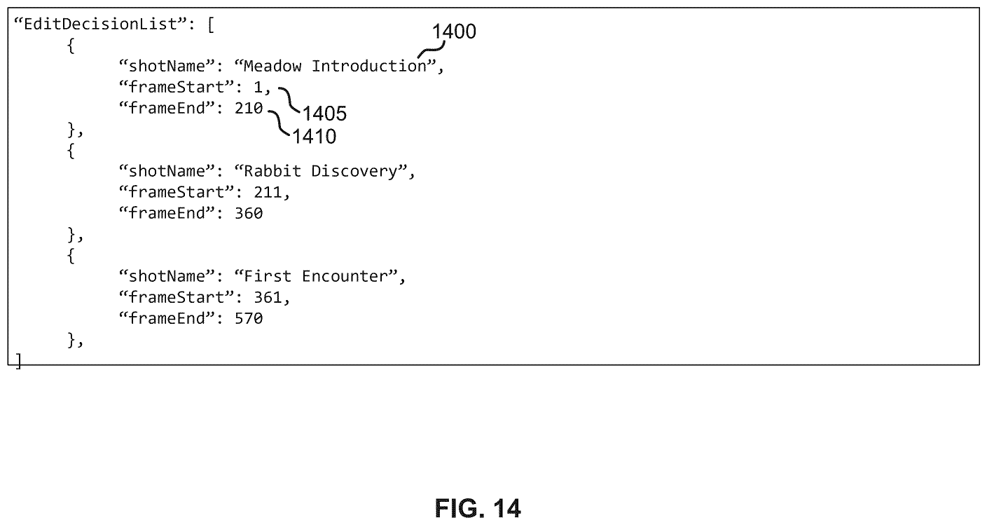

FIG. 14 shows an example of an edit decision list according to aspects of the present disclosure. The example shown includes shot name attribute 1400, frame start attribute 1405, and frame end attribute 1410. The edit decision list is a structured guide for the system to compose the final video. It specifies which scene videos to use, the start and end points for each scene, and the order in which they should be arranged. The shot name attribute 1400 identifies the scene or shot to be used, while the frame start attribute 1405 and frame end attribute 1410 define which frames of the final story video the scene video is contained in. In some embodiments, the system reads the edit decision list as a JSON object and uses this information to stitch the corresponding scene videos together. The final video is then composed by assembling the selected frames from each scene video according to the timing and sequence provided by the edit decision list.

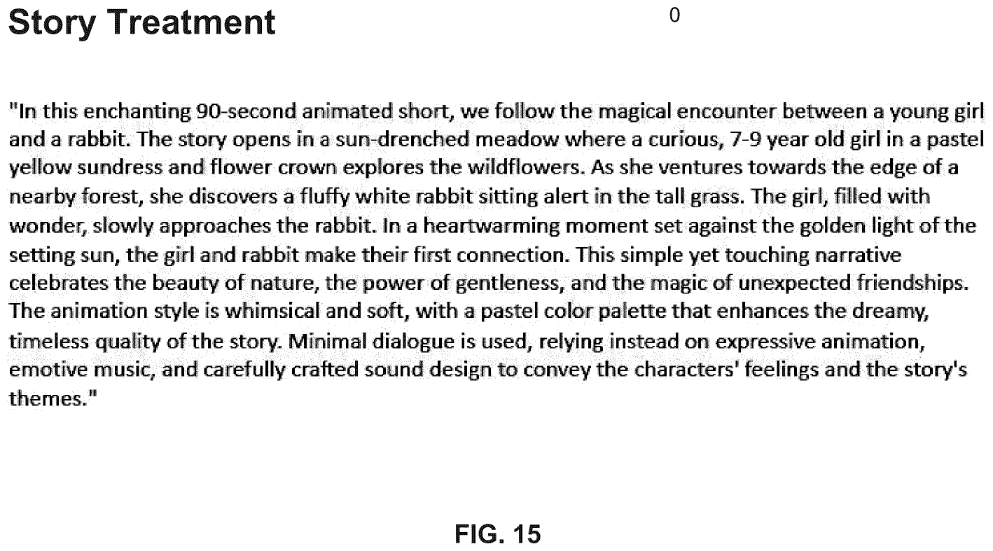

FIG. 15 shows an example of a story treatment output according to aspects of the present disclosure. As used herein, a “treatment” is a summary of the story. The treatment may be generated by the text generation model as described herein. The treatment may be generated using a combination of the previously generated text, image, sound, and video assets.

### Generating Videos Depicting a Story

FIG. 16 shows an example of a method 1600 for providing a story video to a user according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1605, the user provides an input prompt. This prompt includes a description of the story the user wants to generate, including potential details about scenes, characters, and any specific elements they wish to see in the final video. The input prompt may be very detailed, such as the full script of a story, one or more paragraphs describing the story, or very simple, e.g. “a rabbit and a girl.” The input prompt serves as the starting point for the system's story generation process.

At operation 1610, the system generates initial scenes. Based on the input prompt, the system processes the text using a text generation model to create a structured outline, referred to herein as a story recipe. This story recipe includes scene descriptions and character information. The story recipe also includes generation prompts which are used to generate keyframe images for each scene. The contents of the story recipe and the additional generated assets are assembled into a storyboard user interface.

At operation 1615, the user provides edits. After reviewing the initial scenes, the user can make adjustments to the scene descriptions, keyframes, characters, or pacing via the storyboard interface.

At operation 1620, the system generates final scenes based on the edits. Once the user has finalized their changes, the system updates the story recipe and generates scene videos. The updated keyframes and scene descriptions are used to create more refined scene videos that better align with the user' vision.

At operation 1625, the system composes a synthetic video based on the edited storyboard. The system uses the final scene videos and additional assets, such as sound or music, to compose the complete synthetic video. This composition process is guided by the Edit Decision List, which organizes the scene videos in the correct sequence, defines transitions between scenes, and synchronizes any accompanying audio. The final output is a cohesive story video of length and complexity configured by the user that visually and audibly tells the story described by the user.

FIG. 17 shows a diffusion process 1700 according to aspects of the present disclosure. In some examples, diffusion process 1700 describes an operation of the image generation model 230 described with reference to FIG. 2, such as the reverse diffusion process 340 of guided diffusion model 300 described with reference to FIG. 3. According to some aspects, the diffusion process can also be used in the generation of sounds and videos.

As described above with reference to FIG. 3, using a diffusion model can involve both a forward diffusion process 1705 for adding noise to an image (or features in a latent space) and a reverse diffusion process 1710 for denoising the images (or features) to obtain a denoised image. The forward diffusion process 1705 can be represented as q(xₜ|xₜ₋₁), and the reverse diffusion process 1710 can be represented as p(xₜ₋₁|xₜ). In some cases, the forward diffusion process 1705 is used during training to generate images with successively greater noise, and a neural network is trained to perform the reverse diffusion process 1710 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 1710, the model begins with noisy data x_{T}, such as a noisy image 1715 and denoises the data to obtain the p(xₜ₋₁|xₜ). At each step t−1, the reverse diffusion process 1710 takes xₜ, such as first intermediate image 1720, and t as input. Here, t represents a step in the sequence of transitions associated with different noise levels, The reverse diffusion process 1710 outputs xₜ₋₁, such as second intermediate image 1725 iteratively until x_{T} reverts back to x₀, the original image 1730. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) \qquad ( 2 )$$

where p(x_{T})=N(x_{T};0,I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At inference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and \tilde{x} represents the generated image with high image quality.

FIG. 18 is a flow diagram depicting an algorithm as a step-by-step procedure 1800 in an example implementation of operations performable for training a machine-learning model. In some embodiments, the procedure 1800 describes an operation of the training component described for configuring the generative models described with reference to FIG. 2. The procedure 1800 provides one or more examples of generating training data, use of the training data to train a machine-learning model, and use of the trained machine-learning model to perform a task.

To begin in this example, a machine-learning system collects training data (block 1802) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1804) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1806). Initialization of the machine-learning model includes selecting a model architecture (block 1808) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1810). The loss function is utilized to measure a difference between an output of the machine-learning model (i.e., predictions) and target values (e.g., as expressed by the training data) to be used to train the machine-learning model. Additionally, an optimization algorithm is selected (1812) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1814) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1818) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1820), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1820), the procedure 1800 continues training of the machine-learning model using the training data (block 1818) in this example.

If the stopping criterion is met (“yes” from decision block 1820), the trained machine-learning model is then utilized to generate an output based on subsequent data (block 1822). The trained machine-learning model, for instance, is trained to perform a task as described above and therefore, once trained is configured to perform that task based on subsequent data received as an input and processed by the machine-learning model.

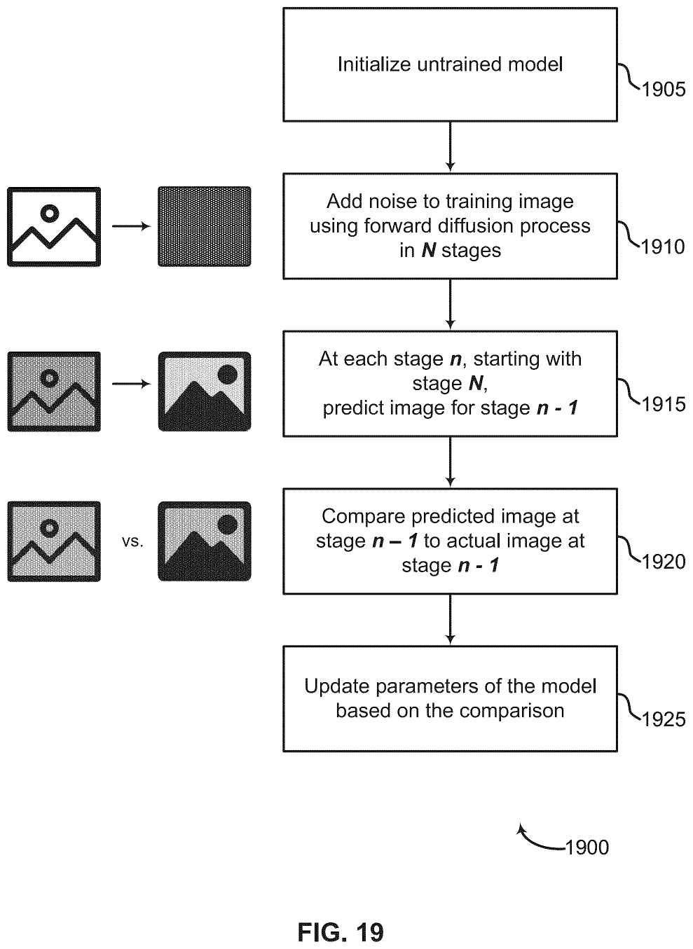

FIG. 19 shows an example of a method 1900 for training a diffusion model according to aspects of the present disclosure. In some embodiments, the method 1900 describes an operation of the training component described for configuring the generative models as described with reference to FIG. 2. The method 1900 represents an example for training a reverse diffusion process as described above with reference to FIG. 17. In some examples, these operations are performed by a system including a processor executing a set of codes to control functional elements of an apparatus, such as the guided diffusion model described in FIG. 3.

Additionally or alternatively, certain processes of method 1900 may be performed using special-purpose hardware. Generally, these operations are performed according to the methods and processes described in accordance with aspects of the present disclosure. In some cases, the operations described herein are composed of various substeps or are performed in conjunction with other operations.

At operation 1905, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1910, the system adds noise to a training image using a forward diffusion process in N stages. In some cases, the forward diffusion process is a fixed process where Gaussian noise is successively added to an image. In latent diffusion models, the Gaussian noise may be successively added to features in a latent space.

At operation 1915, the system at each stage n, starting with stage N, a reverse diffusion process is used to predict the image or image features at stage n−1. For example, the reverse diffusion process can predict the noise that was added by the forward diffusion process, and the predicted noise can be removed from the image to obtain the predicted image. In some cases, an original image is predicted at each stage of the training process.

At operation 1920, the system compares predicted image (or image features) at stage n−1 to an actual image (or image features), such as the image at stage n−1 or the original input image. For example, given observed data x, the diffusion model may be trained to minimize the variational upper bound of the negative log-likelihood −log p_{θ}(x) of the training data.

At operation 1925, the system updates parameters of the model based on the comparison. For example, parameters of a U-Net may be updated using gradient descent. Time-dependent parameters of the Gaussian transitions can also be learned.

FIG. 20 shows an example of a computing device 2000 according to aspects of the present disclosure. The example shown includes computing device 2000, processor(s) 2005, memory subsystem 2010, communication interface 2015, I/O interface 2020, user interface component(s), and channel 2030.

In some embodiments, computing device 2000 is an example of, or includes aspects of, a video processing apparatus as described in FIGS. 1 and 2. In some embodiments, computing device 2000 includes one or more processors 2005 are configured to execute instructions stored in memory subsystem 2010 to obtain a story prompt describing a story; generate, using a text generation model, a story recipe based on the story prompt, wherein the story recipe includes a plurality of scene recipes, wherein each of the plurality of scene recipes includes a plurality of structured attributes; generate, using a video generation model, a plurality of scene videos based on the plurality of scene recipes, respectively; and generate a synthetic video depicting the story by combining the plurality of scene videos.

According to some aspects, computing device 2000 includes one or more processors 2005. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 2010 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. The memory may store various parameters of machine learning models used in the components described with reference to FIG. 2. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 2015 operates at a boundary between communicating entities (such as computing device 2000, one or more user devices, a cloud, and one or more databases) and channel 2030 and can record and process communications. In some cases, communication interface 2015 is provided to enable a processing system coupled to a transceiver (e.g., a transmitter and/or a receiver). In some examples, the transceiver is configured to transmit (or send) and receive signals for a communications device via an antenna.

According to some aspects, I/O interface 2020 is controlled by an I/O controller to manage input and output signals for computing device 2000. In some cases, I/O interface 2020 manages peripherals not integrated into computing device 2000. In some cases, I/O interface 2020 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 2020 or via hardware components controlled by the I/O controller.

According to some aspects, user interface component(s) 2025 enable a user to interact with computing device 2000. In some cases, user interface component(s) 2025 include an audio device, such as an external speaker system, an external display device such as a display screen, an input device (e.g., a remote-control device interfaced with a user interface directly or through the I/O controller), or a combination thereof. In some cases, user interface component(s) 2025 include a GUI.

FIG. 21 shows an example of a guided diffusion transformer (DiT) model according to aspects of the present disclosure. The example shown includes noised latent 2100, patchify operation 2105, timestep embedding 2110, DiT block(s), layer normalization 2120, linear and reshape layers 2125, predicted noise 2130, input tokens 2135, conditioning tokens 2140, self-attention 2145, cross-attention 2150, and feed-forward network 2155.

The following describes a generative process for producing images but may be applied for generating sounds and videos as described with reference to FIG. 2. The DiT architecture processes noised latent 2100, which may be a noised version of an input image encoded in a latent space. Patchify operation 2105 divides the noised latent into a sequence of patches that are processed as tokens. The tokens are vector representations of each patch of the image in latent space and are adjusted through attention processes. Each of the tokens also receives timestep embedding 2110, which encodes the current denoising timestep, and a positional embedding which encodes each token's spatial position in the image. The tokens and timestep information are processed through N DiT block(s) 2115, where N may be 28 in some embodiments, though other values of N are possible.

Each DiT block 2115 includes multiple processing stages. Initially, a pruning operation may be performed where a router model (e.g., a lightweight trained neural network) ranks the input tokens based on an order of importance and selects a number of the tokens to be either processed at the next stage or skipped in the next stage. The selected tokens are processed as input tokens 2135, which interact with conditioning tokens 2140 through multiple attention mechanisms. Self-attention 2145 allows input tokens to attend to each other, while cross-attention 2150 enables input tokens to attend to the conditioning tokens 2140. The outputs are then processed through feed-forward network 2155. This process repeats for each DiT block in the sequence.

After processing through all DiT blocks, the outputs undergo layer normalization 2120 followed by linear and reshape layers 2125. The final output is predicted noise 2130, which represents the model's prediction of the noise that was added to create the initial noised latent 2100. The predicted noise 2130 is removed noised latent 2100 at each diffusion timestep. At the end of the denoising schedule, the latent sample is decoded to generate the synthetic image in pixel space. According to some aspects, the DiT-based model may be used to generate videos by generating a plurality of frames. Additional adaptations to the model such as temporal layers or one or more temporal loss(es) applied during training may be used to enforce temporal cohesion between frames.

Accordingly, the present disclosure includes a method for video generation is described. One or more aspects of the method include obtaining a story prompt describing a story; generating, using a text generation model, a story recipe based on the story prompt, wherein the story recipe includes a plurality of scene recipes, wherein each of the plurality of scene recipes includes a plurality of structured attributes; generating, using a video generation model, a plurality of scene videos based on the plurality of scene recipes, respectively; and generating a synthetic video depicting the story by combining the plurality of scene videos.

Some examples of the method, apparatus, non-transitory computer readable medium, and system further include augmenting the story prompt with a description of a format for the story recipe to obtain an augmented prompt, wherein the story recipe is generated based on the augmented prompt. Some examples of the method, apparatus, non-transitory computer readable medium, and system further include autoregressively generating a sequence of tokens corresponding to the story recipe.

In some aspects, the story recipe comprises a character recipe including a plurality of structured attributes for a character in the story. Some examples of the method, apparatus, non-transitory computer readable medium, and system further include generating, using an image generation model, a character image based on the character recipe, wherein each of the plurality of scenes is based on the character image. In some aspects, the story recipe describes a dialogue, wherein the synthetic video includes audio corresponding to the dialogue. In some aspects, the story recipe includes camera view information, wherein the synthetic video is based on the camera view information.

Some examples of the method, apparatus, non-transitory computer readable medium, and system further include receiving an edit command. Some examples further include updating the story recipe based on the edit command to obtain an updated story recipe, wherein the synthetic video is based on the updated story recipe.

The description and drawings described herein represent example configurations and do not represent all the implementations within the scope of the aspects. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following aspects, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a story prompt describing a story;
generating, using a text generation model, a story recipe based on the story prompt, wherein the story recipe includes a plurality of scene recipes;
generating, using a video generation model, a plurality of scene videos based on the plurality of scene recipes, respectively; and
generating a synthetic video depicting the story by combining the plurality of scene videos.

2. The method of claim 1, further comprising:
augmenting the story prompt with a description of a format for the story recipe to obtain an augmented prompt, wherein the story recipe is generated based on the augmented prompt.

3. The method of claim 1, further comprising:
autoregressively generating a sequence of tokens corresponding to the story recipe.

4. The method of claim 1, wherein:
each of the plurality of scene recipes includes a plurality of structured attributes.

5. The method of claim 1, wherein:
the story recipe comprises a character recipe for a character in the story, wherein the character appears in each of the plurality of scene videos.

6. The method of claim 5, further comprising:
generating, using an image generation model, a character image based on the character recipe, wherein each of the plurality of scene videos is based on the character image.

7. The method of claim 1, wherein:
the story recipe describes a dialogue, wherein the synthetic video includes audio corresponding to the dialogue.

8. The method of claim 1, wherein:
the story recipe includes camera view information, wherein the synthetic video is based on the camera view information.

9. The method of claim 1, further comprising:
receiving an edit command; and
updating the story recipe based on the edit command to obtain an updated story recipe, wherein the synthetic video is based on the updated story recipe.

10. A non-transitory computer readable medium storing code for video generation, the code comprising instructions that, when executed by at least one processor, cause the at least one processor to perform operations comprising:
obtaining a story prompt describing a story;
generating, using a text generation model, a story recipe based on the story prompt, wherein the story recipe includes a plurality of scene recipes;
updating a scene recipe of the plurality of scene recipes based on an edit command; and
generating, using a video generation model, a synthetic video depicting the story based on the plurality of scene recipes.

11. The non-transitory computer readable medium of claim 10, the code further comprising instructions that, when executed by the at least one processor, cause the at least one processor to perform operations comprising:
generating, using the video generation model, a plurality of scene videos based on the plurality of scene recipes, respectively, wherein the synthetic video includes the plurality of scene videos.

12. The non-transitory computer readable medium of claim 10, the code further comprising instructions that, when executed by the at least one processor, cause the at least one processor to perform operations comprising:
augmenting the story prompt with a description of a format for the story recipe to obtain an augmented prompt, wherein the story recipe is generated based on the augmented prompt.

13. The non-transitory computer readable medium of claim 10, wherein:
the story recipe comprises a character recipe for a character in the story, wherein the character appears in the synthetic video.

14. The non-transitory computer readable medium of claim 13, the code further comprising instructions that, when executed by the at least one processor, cause the at least one processor to perform operations comprising:
generating, using an image generation model, a character image based on the character recipe, wherein the synthetic video is based on the character image.

15. The non-transitory computer readable medium of claim 10, wherein:
the story recipe describes a dialogue, wherein the synthetic video includes audio corresponding to the dialogue.

16. The non-transitory computer readable medium of claim 10, wherein:
the story recipe includes camera view information, wherein the synthetic video is based on the camera view information.

17. A system comprising:
a memory component; and
a processing device coupled to the memory component, the processing device
configured to perform operations comprising:
obtaining a story prompt describing a story;
generating, using a text generation model, a story recipe based on the story prompt, wherein the story recipe includes a plurality of scene recipes;
generating, using a video generation model, a plurality of scene videos based on the plurality of scene recipes, respectively; and
generating a synthetic video depicting the story by combining the plurality of scene videos.

18. The system of claim 17, the processing device being further configured to perform operations comprising:
augmenting the story prompt with a description of a format for the story recipe to obtain an augmented prompt, wherein the story recipe is generated based on the augmented prompt.

19. The system of claim 17, wherein:
the story recipe comprises a character recipe including a plurality of structured attributes for a character in the story.

20. The system of claim 19, the processing device being further configured to perform operations comprising:
generating, using an image generation model, a character image based on the character recipe, wherein each of the plurality of scenes is based on the character image.
